(19) United States
(12) Patent Application Publication
(10) Pub. No.: US 2025/0180934 A1
(43) Pub. Date: Jun. 5, 2025

(54) BIAS CONTROL DEVICE AND METHOD BASED ON PULSE PHASE STABILIZATION FOR MACH-ZEHNDER MODULATOR

(71) Applicant: ZHEJIANG SCI-TECH UNIVERSITY, Zhejiang (CN)

(72) Inventors: Benyong CHEN, Zhejiang (CN); Jiandong XIE, Zhejiang (CN); Liping YAN, Zhejiang (CN); Ye LIN, Zhejiang (CN)

(73) Assignee: ZHEJIANG SCI-TECH UNIVERSITY, Zhejiang (CN)

(21) Appl. No.: 19/021,309

(22) Filed: Jan. 15, 2025

Related U.S. Application Data
(63) Continuation of application No. PCT/CN2024/087499, filed on Apr. 12, 2024.

(30) Foreign Application Priority Data
Jul. 7, 2023 (CN) 202310836700.3

(51) Int. Cl. G02F 1/01; G02F 1/21; G02F 1/225

(52) U.S. Cl. CPC G02F 1/0123; G02F 1/212; G02F 1/225

(57) ABSTRACT

The present disclosure discloses a bias control device and method based on pulse phase stabilization for adaptive Mach-Zehnder modulator. The device includes a mode-locked femtosecond laser, a Mach-Zehnder modulator, an optical fiber coupler, a photodetector, an amplifying filter, an analog-to-digital converter, an FPGA bias control module, a digital-to-analog converter, a bias amplifier, and an electrical pulse generator. The FPGA bias control module demodulates the amplitude of the high-frequency signal to determine and output the initial bias value, setting the operating point of MZM at the Null point. Simultaneously, the low-frequency signal phase at this moment is demodulated as the target value and compared with the demodulated phase of the real-time updated low-frequency signal to generate an error signal. Through PID, the bias voltage is adjusted in real time to achieve stability at the Null point.

### CROSS-REFERENCE TO RELATED APPLICATION

This application is a continuation of international application of PCT application serial no. PCT/CN2024/087499, filed on Apr. 12, 2024, which claims the priority benefit of China application no. 202310836700.3 filed on Jul. 7, 2023. The entirety of each of the above mentioned patent applications is hereby incorporated by reference herein and made a part of this specification.

### TECHNICAL FIELD

The present disclosure belongs to a control method for a Mach-Zehnder modulator in the field of ultrafast interferometric imaging, more specifically, relates to a bias control device and method based on pulse phase stabilization for an adaptive Mach-Zehnder modulator.

### DESCRIPTION OF RELATED ART

Ultrafast optical imaging is a means of imaging transient events using ultrashort pulses. By matching the repetition frequency of femtosecond pulses with the exposure time of the camera, single-pulse imaging may be achieved, thereby enabling observation of transient physical phenomena and chemical reactions on a femtosecond time scale. Such technology has important applications in the dynamic analysis of ultrafast phenomena in biomedical, precision manufacturing, and scientific research fields.

In ultrafast optical imaging systems, laser pulses are typically generated through frequency reduction by modulators. The advantages of the Mach-Zehnder Modulator (MZM) include, for example, low driving voltage, high modulation bandwidth, wide wavelength performance, ultra-short rise time, and no chirp, making MZM as an appropriate alternative for fast pulse-picking. By controlling the operating point of the MZM at the Null point and applying a square wave radio frequency signal, the MZM acts as a fast optical switch that blocks or transmits pulse light at the low or high level of the square wave signal, serving the purpose of pulse selection. However, when the ambient temperature changes, the operating point of the MZM is prone to drift, which will severely affect the performance of pulse picking. Therefore, automatic bias control technology is needed to adjust the bias voltage in real time to achieve operating point locking.

Existing modulator bias control techniques are mainly divided into two categories: methods based on direct optical power monitoring and methods based on low-frequency dither signals. The method based on optical power monitoring utilizes the absolute value of output optical power or the ratio of input to output optical power as the monitoring feedback signal. Such method may be significantly affected by fluctuations in input optical power, resulting in lower accuracy.

The method based on dither signal is to apply a kilohertz low-frequency dither signal to the DC bias terminal of the MZM, and use the fundamental frequency or harmonic of the demodulated original dither signal as a feedback signal to control the bias point. However, such method introduces additional modulation in the output signal, which might reduce the extinction ratio of the output pulse.

### SUMMARY

In view of the deficiencies in the existing technology, the purpose of the present disclosure lies in providing a bias control device and method based on pulse phase stabilization for a self-adaptive Mach-Zehnder modulator to solve the problem of extinction ratio degradation of output pulses caused by bias operating point drift, thereby improving the bias control accuracy of the modulator.

The present disclosure adopts a method of maintaining pulse phase stability to stabilize the Mach-Zehnder modulator (MZM) at the Null point without introducing additional noise. The present disclosure may improve the bias control accuracy, ensure long-term stability of the operating point, and realize high extinction ratio output of laser pulses at arbitrary frequencies.

The present disclosure implements the above-mentioned purpose by adopting the following specific technical solution:

I. A bias control device based on pulse phase stabilization for a Mach-Zehnder modulator includes a mode-locked femtosecond laser, a Mach-Zehnder modulator, an optical fiber coupler, a photodetector, a first amplifying filter, a first analog-to-digital converter, a second amplifying filter, a second analog-to-digital converter, an FPGA bias control module, a digital-to-analog converter, a bias amplifier and an electrical pulse generator.

The output terminal of the mode-locked femtosecond laser is connected to the input terminal of the Mach-Zehnder modulator. The output terminal of the Mach-Zehnder modulator is connected to the input terminal of the optical fiber coupler. One output terminal of the optical fiber coupler is connected to the input terminal of the photodetector. The electrical output terminal of the photodetector is connected to the input terminal of the first amplifying filter and the input terminal of the second amplifying filter respectively. The output terminal of the first amplifying filter and the output terminal of the second amplifying filter are connected to the input terminal of the first analog-to-digital converter and the input terminal of the second analog-to-digital converter respectively. The output terminal of the first analog-to-digital converter and the output terminal of the second analog-to-digital converter are both connected to the FPGA bias control module. The FPGA bias control module is connected to the bias control terminal of the Mach-Zehnder modulator through a digital-to-analog converter and a bias amplifier in sequence. The electrical pulse generator is connected to the RF radio frequency input terminal of the Mach-Zehnder modulator.

The first amplifying filter is a low-pass filter, and the second amplifying filter is a band-pass filter.

The FPGA bias control module includes a first phase-locked amplifier, a second phase-locked amplifier, and a bias generator. The input terminals of the first phase-locked amplifier and the second phase-locked amplifier are connected to the output terminal of the first analog-to-digital converter and the output terminal of the second analog-to-digital converter, respectively. The output terminal of the first phase-locked amplifier and the output terminal of the second phase-locked amplifier are both connected to the input terminal of the bias generator. The output terminal of the bias generator is connected to the input terminal of the digital-to-analog converter.

The two output terminals of the optical fiber coupler conduct light splitting processing, separating a small portion of light to the photodetector for further bias control.

II. A bias control method based on a bias control device for a Mach-Zehnder modulator:

The optical pulse with wavelength λ and repetition frequency fᵣₑₚ output from the mode-locked femtosecond laser is coupled into the Mach-Zehnder modulator. The electrical pulse generator outputs an electrical pulse signal with a frequency f_{pick} to the RF radio frequency input terminal of the Mach-Zehnder modulator for pulse modulation, reducing the pulse output frequency to the frequency f_{pick}. The Mach-Zehnder modulator outputs the optical pulse signal to the optical fiber coupler. Through the optical fiber coupler, a portion of the light is separated and detected by the photodetector. The optical pulse signal is converted into an electrical signal by the photodetector and divided into two paths. Along one path, the light passes through the first amplifying filter and the first analog-to-digital converter to obtain a low-frequency digital signal S₁(t) with the same frequency f_{pick} as the electrical pulse signal. Along the other path, the light passes through the second amplifying filter and the second analog-to-digital converter to obtain a high-frequency digital signal S₂(t) with the same frequency fᵣₑₚ as the output of the mode-locked femtosecond laser. Finally, the low-frequency digital signal S₁(t) and the high-frequency digital signal S₂(t) are sent to the FPGA bias control module for data processing. The FPGA bias control module processes the signals and outputs a bias control signal V_{b} through the digital-to-analog converter. The bias control signal V_{b} is amplified by the bias amplifier and then configured to control the bias of the Mach-Zehnder modulator.

Bias control specifically controls the voltage phase of the Mach-Zehnder modulator (MZM).

In the FPGA bias control module, the amplitude of the high-frequency digital signal S₂(t) is demodulated by the second phase-locked amplifier 10 and sent to the bias generator 11. After processing by the bias generator 11, the initial Null point bias value Vₙᵤₗₗ is output through the digital-to-analog converter 12, which is then amplified by the bias amplifier 13 and input to the DC bias terminal of MZM2 to set the operating point. The phase of the low-frequency digital signal S₁(t) is demodulated by the first phase-locked amplifier 7 and sent to the bias generator 11. After processing by the bias generator 11, the bias control signal V_{b} is output through the digital-to-analog converter 12, which is then amplified by the bias amplifier 13 and input to the DC bias terminal of MZM2 to stabilize the operating point.

In the initial situation, the bias generator of the FPGA bias control module scans a cycle of triangular wave voltage for the bias control signal V_{b}, and sets the frequency f_{pick} of the electrical pulse signal output by the electrical pulse generator as zero, i.e. Eₚ=0. Then, the second phase-locked amplifier demodulates the amplitude A₂ of the high-frequency digital signal S₂(t) in real time, and obtains the bias control signal V_{b} corresponding to the minimum amplitude A₂ through scanning as the initial bias Vₙᵤₗₗ to be input into the Mach-Zehnder modulator.

In the meantime, the phase β₀ of the low-frequency digital signal obtained according to the low-frequency signal phase demodulation formula at this time set as the target value, which is compared with the phase β of the real-time demodulated low-frequency signal in the bias generator to generate an error feedback signal. The bias generator outputs a real-time adjusted bias voltage V_{b} to closed-loop control and lock the Null operating point, thereby implementing pulse picking with high extinction ratio.

The technical principle of the present disclosure is as follows:

The electrical pulse generator 14 outputs a radio frequency pulse signal Eₚ to the Mach-Zehnder modulator MZM to pick optical pulses with a repetition frequency fᵣₑₚ. According to the modulation transfer function of the Mach-Zehnder modulator MZM, the output optical intensity Pₒᵤₜ of the Mach-Zehnder modulator MZM can be expressed as follows:

$${P}_{out} = \frac{k}{2} {E}_{i n}^{2} [ 1 + cos ( π \frac{{E}_{P}}{{V}_{π}} + π \frac{{K}_{1} {V}_{b} + {V}_{σ}}{{V}_{π}} ) ]$$

In the formula, Eᵢₙ represents the output light field of the mode-locked femtosecond laser, k represents the insertion loss of the Mach-Zehnder modulator MZM, K₁ represents the gain of the bias amplifier, V_{π} represents the half-wave voltage of the Mach-Zehnder modulator MZM, Eₚ represents the radio frequency pulse signal, V_{b} represents the bias control signal, and V_{σ} represents the equivalent bias voltage corresponding to a random phase drift.

From the above equation, it may be known that when Eₚ=0, and (K₁V_{b}+V_{σ})=V_{π}, the Mach-Zehnder modulator MZM works at an OFF state, the optical pulse is blocked, and this bias voltage value V_{b} is called the Null point voltage Vₙᵤₗₗ.

Further, by expanding the above output light intensity formula of the Mach-Zehnder modulator MZM, the signal detected by the photodetector is represented as follows:

$$S ( t ) = \frac{k}{2} {E}_{i n}^{2} + \frac{k}{2} {E}_{i n}^{2} cos ( π \frac{{E}_{P}}{{V}_{π}} ) cos ( π \frac{{K}_{1} {V}_{b} + {V}_{σ}}{{V}_{π}} ) - \frac{k}{2} {E}_{i n}^{2} sin ( π \frac{{E}_{P}}{{V}_{π}} ) sin ( π \frac{{K}_{1} {V}_{b} + {V}_{σ}}{{V}_{π}} )$$

In the above formula, the output light field Eᵢₙ of the mode-locked femtosecond laser 1 is represented as follows:

$${E}_{i n} = {\sum }_{n = 1}^{∞} {A}_{n} cos [ 2 π ( {nf}_{rep} + {f}_{ceo} ) t + {φ}_{n} ]$$

In the formula, f_{ceo} is the carrier-envelope offset frequency, n is the number of combs, and Aₙ and φₙ represent the amplitude and phase of the n-th comb, respectively, and t represents the light beam propagation time.

In the above formula, for a periodic electrical pulse signal Eₚ with a frequency of f_{pick}, its Fourier series expansion can be expressed as follows:

$${E}_{P} = {B}_{0} + {\sum }_{m = 1}^{∞} {B}_{m} cos ( m 2 π {f}_{pick} t + {ϕ}_{m} )$$

In the formula, B₀ represents the DC component, Bₘ and φₘ represent the amplitude and phase of the m-th harmonic component respectively, and m represents the harmonic order of frequency f_{pick}.

Substituting the output light field Eᵢₙ and the electrical pulse signal Eₚ expressions into the output light intensity expansion formula of the Mach-Zehnder modulator MZM, and performing low-pass filtering on S(t) with the first amplifying filter's cut-off frequency of approximately 1.5f_{pick}, the low-frequency digital signal S₁(t) is obtained, which can be expressed as follows:

$${S}_{1} ( t ) = {S}_{10} + {S}_{11} cos ( 2 π {f}_{pick} t + {Φ}_{1} ) cos ( π \frac{{K}_{1} {V}_{b} + {V}_{σ}}{{V}_{π}} ) - {S}_{11} cos ( 2 π {f}_{pick} t + {Φ}_{2} ) sin ( π \frac{{K}_{1} {V}_{b} + {V}_{σ}}{{V}_{π}} )$$

In the formula, S₁₀ is the DC component, S₁₁ and S₁₂ are coefficients of the second and third terms respectively, Φ₁ and Φ₂ are phase constants of the second and third terms respectively. In specific implementation, S₁₁, S₁₂, Φ₁ and Φ₂ are all constants related to the amplitude and phase of Eᵢₙ and Eₚ.

The above formula is further simplified as follows:

$$\{ \begin{matrix}{S}_{1} ( t ) = {S}_{10} + C cos ( 2 π {f}_{pick} t - β ) \\ C = \sqrt{{S}_{11}^{2} {cos}^{2} θ + {S}_{12}^{2} {sin}^{2} θ + {S}_{11} {S}_{12} sin 2 θ cos ( {Φ}_{1} - {Φ}_{2} )} \\ β = - arc tan \frac{{S}_{11} sin {Φ}_{1} + {S}_{12} sin {Φ}_{2} tan θ}{{S}_{11} cos {Φ}_{1} + {S}_{12} cos {Φ}_{2} tan θ} \\ θ = π \frac{{K}_{1} {V}_{b} + {V}_{σ}}{{V}_{π}}\end{matrix}$$

In the formula, C represents amplitude, θ represents the phase of the operating point of MZM.

From this formula, it can be seen that the phase β of the low-frequency digital signal S₁(t) is in one-to-one correspondence with the operating point θ of the Mach-Zehnder modulator MZM. If the phase of the low-frequency digital signal S₁(t) corresponding to initial Vₙᵤₗₗ is set as β₀, the drift of V_{σ} can be compensated by adjusting the bias voltage V_{b} to keep the phase β₀ of the low-frequency digital signal S₁(t) steady, thereby locking the operating point at the Null point (zero point).

The FPGA bias control module of the present disclosure demodulates the amplitude of the high-frequency signal to determine and output the initial bias value, setting the operating point of the Mach-Zehnder modulator MZM at the Null point. Meanwhile, the phase of the low-frequency signal at this moment is demodulated as the target value and compares the demodulated phase with the demodulated phase of the real-time updated low-frequency signal to generate an error signal. Through PID, the bias voltage is adjusted in real time to achieve stability at the Null point.

The advantageous effects of the present disclosure are as follows:

(1) The present disclosure adopts a method of maintaining pulse phase stability to implement the operating point of a Mach-Zehnder modulator MZM, locking the optimal operating point of the modulator without introducing additional noise, thus achieving pulse picking with high extinction ratio.

(2) The present disclosure adopts an orthogonal demodulation algorithm to accurately set and stabilize the operating point of the Mach-Zehnder modulator MZM, which has a very high bias control accuracy.

### BRIEF DESCRIPTION OF THE DRAWINGS

FIG. 1 illustrates the principle of a device and a method of the present disclosure.

FIG. 2 is a flow chart of a bias control method for operating point of MZM of the present disclosure.

FIG. 3 is a comparison diagram of optical power output over 1 hour with and without bias control of the Mach-Zehnder modulator MZM according to the present disclosure.

In the FIG.: 1. mode-locked femtosecond laser, 2. Mach-Zehnder modulator (MZM), 3. optical fiber coupler, 4. photodetector, 5. first amplifying filter, 6. first analog-to-digital converter, 7. first phase-locked amplifier, 8. second amplifying filter, 9. second analog-to-digital converter, 10. second phase-locked amplifier, 11. bias generator, 12. digital-to-analog converter, 13. bias amplifier, 14. electrical pulse generator

### DESCRIPTION OF THE EMBODIMENTS

The following detailed description of the present disclosure is provided in conjunction with the accompanying drawings and embodiments.

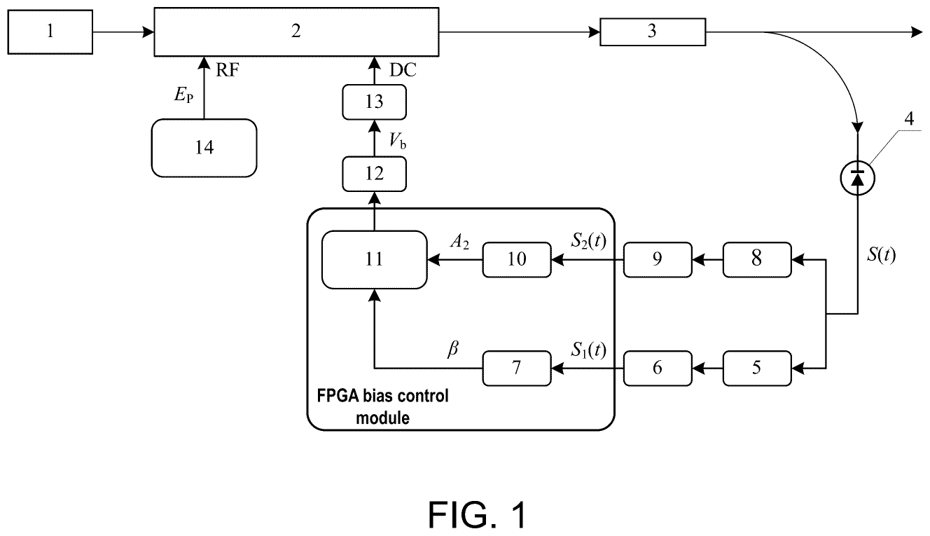

As shown in FIG. 1, an embodiment of the present disclosure specifically includes a mode-locked femtosecond laser 1, a Mach-Zehnder modulator 2, an optical fiber coupler 3, a photodetector 4, a first amplifying filter 5, a first analog-to-digital converter 6, a second amplifying filter 8, a second analog-to-digital converter 9, an FPGA bias control module, a digital-to-analog converter 12, a bias amplifier 13 and an electrical pulse generator 14. The output terminal of the mode-locked femtosecond laser 1 is connected to the input terminal of the Mach-Zehnder modulator 2. The output terminal of the Mach-Zehnder modulator 2 is connected to the input terminal of the optical fiber coupler 3. One output terminal of the optical fiber coupler 3 is configured to connect to externally required devices. Another output terminal of the optical fiber coupler 3 is connected to the input terminal of the photodetector 4. The electrical output terminal of the photodetector 4 is connected to the input terminal of the first amplifying filter 5 and the input terminal of the second amplifying filter 8 respectively. The output terminal of the first amplifying filter 5 and the output terminal of the second amplifying filter 8 are connected to the input terminal of the first analog-to-digital converter 6 and the input terminal of the second analog-to-digital converter 9 respectively. The output terminal of the first analog-to-digital converter 6 and the output terminal of the second analog-to-digital converter 9 are both connected to the FPGA bias control module. The FPGA bias control module is connected to the bias control terminal of the Mach-Zehnder modulator 2 through a digital-to-analog converter 12 and a bias amplifier 13 in sequence. The electrical pulse generator 14 is connected to the RF radio frequency input terminal of the Mach-Zehnder modulator 2.

The first amplifying filter 5 is a low-pass filter, and the second amplifying filter 8 is a band-pass filter.

The FPGA bias control module includes a first phase-locked amplifier 7, a second phase-locked amplifier 10, and a bias generator 11. The input terminals of the first phase-locked amplifier 7 and the second phase-locked amplifier 10 are connected to the output terminal of the first analog-to-digital converter 6 and the output terminal of the second analog-to-digital converter 9, respectively. The output terminal of the first phase-locked amplifier 7 and the output terminal of the second phase-locked amplifier 10 are both connected to the input terminal of the bias generator 11. The output terminal of the bias generator 11 is connected to the input terminal of the digital-to-analog converter 12. The first phase-locked amplifier 7 and the second phase-locked amplifier 10 demodulate the phase of the low-frequency digital signal and the amplitude of the high-frequency digital signal, respectively, which are then sent to the bias generator 11 for processing to output the bias control digital signal.

The optical fiber coupler 3 only has one input terminal and two output terminals. The two output terminals of the optical fiber coupler 3 conduct light splitting processing, separating a small portion of light to the photodetector 4 for further bias control.

Specifically, the implementation may conduct beam splitting processing according to 99:1, wherein 99% is output from the first output terminal and 1% is input to the photodetector 4 from the second output terminal. The light output from the first output terminal is typically used for realizing application scenarios, such as ultrafast imaging, processing micro-nano structural parts, femtosecond laser direct writing, etc.

The specific implementation verification process of the present disclosure is as follows:

The femtosecond laser pulse output from the mode-locked femtosecond laser 1 is coupled into the optical fiber input terminal of the MZM2. The electrical pulse generator 14 outputs an electrical pulse signal Eₚ to the RF radio frequency input terminal of the MZM2 to pick the femtosecond laser pulse with a repetition frequency fᵣₑₚ. According to the modulation transfer function of the MZM2, the output light intensity of the MZM2 is represented as follows:

$${P}_{out} = \frac{k}{2} {E}_{i n}^{2} [ 1 + cos ( π \frac{{E}_{P}}{{V}_{π}} + π \frac{{K}_{1} {V}_{b} + {V}_{σ}}{{V}_{π}} ) ] \qquad ( 1 )$$

In the formula, Eᵢₙ represents the output light field of the mode-locked femtosecond laser 1, k represents the insertion loss of the MZM 2, K₁ represents the gain of the bias amplifier 13, V_{π} represents the half-wave voltage of the MZM 2, and V_{σ} represents the equivalent bias voltage corresponding to a random phase drift.

From formula (1), it may be known that when Eₚ=0, and (K₁V_{b}+V_{σ})=V_{π}, MZM2 works at an OFF state, the optical pulse is blocked, and this bias voltage value V_{b} is called the Null point voltage Vₙᵤₗₗ.

By expanding Formula (1), the electrical signal detected by the photodetector 4 is represented as follows:

$$S ( t ) = \frac{k}{2} {E}_{i n}^{2} + \frac{k}{2} {E}_{i n}^{2} cos ( π \frac{{E}_{P}}{{V}_{π}} ) cos ( π \frac{{K}_{1} {V}_{b} + {V}_{σ}}{{V}_{π}} ) - \frac{k}{2} {E}_{i n}^{2} sin ( π \frac{{E}_{P}}{{V}_{π}} ) sin ( π \frac{{K}_{1} {V}_{b} + {V}_{σ}}{{V}_{π}} ) \qquad ( 2 )$$

The output light field Eᵢₙ of the mode-locked femtosecond laser 1 is represented as follows:

$${E}_{i n} = {\sum }_{n = 1}^{∞} {A}_{n} cos [ 2 π ( {nf}_{rep} + {f}_{ceo} ) t + {φ}_{n} ] \qquad ( 3 )$$

In the formula, f_{ceo} is the carrier-envelope offset frequency, n is the number of combs, and Aₙ and φₙ represent the amplitude and phase of the n-th comb, respectively.

For a periodic pulse signal Eₚ with a frequency f_{pick}, its Fourier series expansion can be expressed as follows:

$${E}_{P} = {B}_{0} + {\sum }_{m = 1}^{∞} {B}_{m} cos ( m 2 π {f}_{pick} t + {ϕ}_{m} ) \qquad ( 4 )$$

In the formula, B₀ is the DC component, Bₘ and φₘ represent the amplitude and phase of the m-th harmonic component, respectively.

By Substituting Formula (3) and Formula (4) to Formula (2), and after applying a low-pass filter with a cut-off frequency of approximately 1.5f_{pick}, the low-frequency digital signal S₁(t) is represented as follows:

$${S}_{1} ( t ) = {S}_{10} + {S}_{11} cos ( 2 π {f}_{pick} t + {Φ}_{1} ) cos ( π \frac{{K}_{1} {V}_{b} + {V}_{σ}}{{V}_{π}} ) - {S}_{11} cos ( 2 π {f}_{pick} t + {Φ}_{2} ) sin ( π \frac{{K}_{1} {V}_{b} + {V}_{σ}}{{V}_{π}} ) \qquad ( 5 )$$

In the formula, S₁₀ is the DC component, S₁₁, S₁₂, Φ₁ and Φ₂ are constants related to the amplitude and phase of Eᵢₙ and Eₚ, respectively.

Formula (5) is further simplified to:

$$\{ \begin{matrix}{S}_{1} ( t ) = {S}_{10} + C cos ( 2 π {f}_{pick} t - β ) \\ C = \sqrt{{S}_{11}^{2} {cos}^{2} θ + {S}_{12}^{2} {sin}^{2} θ + {S}_{11} {S}_{12} sin 2 θ cos ( {Φ}_{1} - {Φ}_{2} )} \\ β = - arc tan \frac{{S}_{11} sin {Φ}_{1} + {S}_{12} sin {Φ}_{2} tan θ}{{S}_{11} cos {Φ}_{1} + {S}_{12} cos {Φ}_{2} tan θ} \\ θ = π \frac{{K}_{1} {V}_{b} + {V}_{σ}}{{V}_{π}}\end{matrix} \qquad ( 6 )$$

As known from Formula (6), the phase β of S₁(t) is in one-to-one correspondence with the operating point θ of the MZM2. The phase of the low-frequency digital signal S₁(t) corresponding to the initial Vₙᵤₗₗ is set be β₀. Then, by adjusting the bias voltage V_{b} to compensate for the drift of V_{σ}, β₀ will be maintained steady, thereby locking the operating point at the Null point.

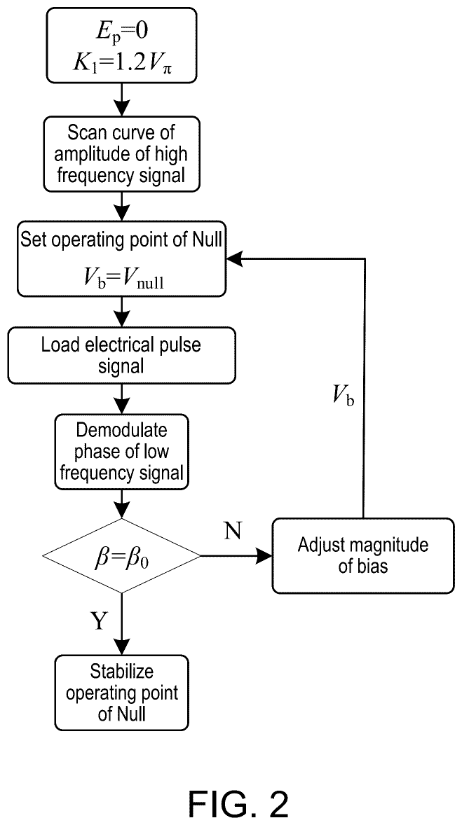

The workflow diagram for MZM2 operating point bias control is shown in FIG. 2. First, it is set that Eₚ=0, K₁=1.2V_{π}, and the bias control signal V_{b} is scanned for a cycle of triangular wave voltage. The second phase-locked amplifier 10 demodulates the amplitude of the high-frequency digital signal S₂(t) in real time, which is represented by the Formula below:

$${A}_{2} = 2 \sqrt{{\{ L P F [ {S}_{2} ( t ) sin ( 2 π {f}_{rep} t ) ] \}}^{2} + {\{ L P F [ {S}_{2} ( t ) cos ( 2 π {f}_{rep} t ) ] \}}^{2}} \qquad ( 7 )$$

The relationship curve between the amplitude A₂ of the high-frequency signal and V_{b} is obtained. The initial bias Vₙᵤₗₗ is the bias voltage V_{b} value corresponding to the minimum amplitude A₂. This bias value Vₙᵤₗₗ is amplified by the bias amplifier 13 and then input to the DC bias terminal of MZM2 to set the operating point. Then, the electrical pulse generator 14 loads the electrical pulse signal Eₚ to the RF radio frequency input terminal of MZM2. According to Formula (6), the first phase-locked amplifier 7 performs demodulation to obtain the phase β₀ of the low-frequency digital signal S₁(t) corresponding to the initial bias Vₙᵤₗₗ. In the bias generator 11, β₀ is set as the target value and compared with the phase β of the real-time demodulated low-frequency signal to generate an error feedback signal. The bias generator 11 adjusts the bias voltage V_{b} in real time through PID closed-loop control to compensate for the random drift V_{σ}, thereby achieving the stability of the operating point of MZM2.

In an embodiment of the disclosure, the mode-locked femtosecond laser 1 adopts the C-Fiber 780 mode-locked fiber femtosecond laser from Menlo Systems, Germany, with a central wavelength of λ=1560 nm; the Mach-Zehnder modulator MZM2 adopts the MXER-LN-10 Mach-Zehnder intensity modulator from iXblue, France; the photodetector 4 adopts the 1611FC-AC fiber-optic receiver photodetector from Newport, USA.

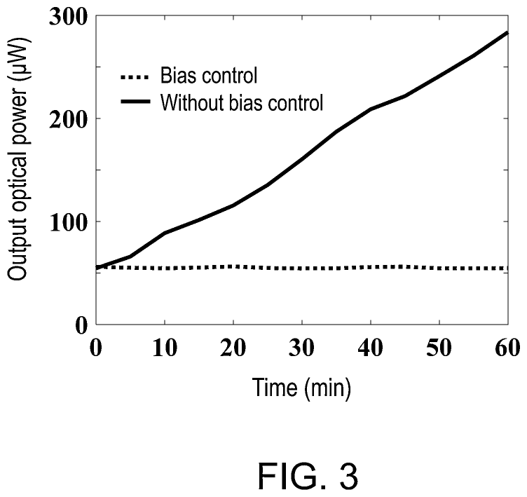

It is set that Eₚ=0, K₁=1.2V_{π}, and the bias control signal V_{b} is scanned for one cycle of the triangular voltage with an amplitude of 1V. The second phase-locked amplifier 10 demodulates the amplitude of the high-frequency digital signal S₂(t) in real time to obtain the relationship curve between the amplitude A₂ of the high-frequency signal and V_{b}, and determines the initial Null point bias Vₙᵤₗₗ when the amplitude A₂ is at its minimum. This bias value Vₙᵤₗₗ is amplified by the bias amplifier 13 and then input to the DC bias terminal of MZM2 to set the operating point. Then, the electrical pulse generator 14 loads an electrical pulse signal Eₚ with an amplitude of V_{π} to the RF radio frequency input terminal of MZM2. According to Formula (7), the phase β₀ of the low-frequency digital signal S₁(t) corresponding to the initial bias Vₙᵤₗₗ is calculated and obtained. β₀ is set as the target value and compared with the phase β of the real-time demodulated low-frequency signal to obtain an error feedback signal. The bias generator 11 adjusts the bias voltage V_{b} in real time to compensate for the random drift V_{σ}, thus completing the closed-loop control of the operating point of MZM2. To validate the effectiveness of the proposed bias control method, a 1-hour comparison experiment of MZM2 output optical power was conducted with and without bias control. The experimental results are shown in FIG. 3.

As can be seen from the above embodiments, the present disclosure adopts a method of maintaining pulse phase stability to implement automatic bias control of the MZM without introducing additional noise. The present disclosure utilizes an orthogonal demodulation algorithm to accurately set and stabilize the operating point of the MZM, improving the bias control accuracy of the system, ensuring long-term stability of the operating point, and achieving high extinction ratio pulse picking, which has outstanding and significant technical effects.

The above-mentioned specific embodiments are used to explain and illustrate the present disclosure, rather than to limit the present disclosure. Any modifications and changes made to the present disclosure within the spirit and scope of protection of the rights claims of the present disclosure fall within the protection scope of the present disclosure.

What is claimed is:

1. A bias control device based on pulse phase stabilization for a Mach-Zehnder modulator, comprising:
a mode-locked femtosecond laser, a Mach-Zehnder modulator, an optical fiber coupler, a photodetector, a first amplifying filter, a first analog-to-digital converter, a second amplifying filter, a second analog-to-digital converter, an FPGA bias control module, a digital-to-analog converter, a bias amplifier and an electrical pulse generator;
an output terminal of the mode-locked femtosecond laser is connected to an input terminal of the Mach-Zehnder modulator, an output terminal of the Mach-Zehnder modulator is connected to an input terminal of the optical fiber coupler, one output terminal of the optical fiber coupler is connected to an input terminal of the photodetector, an electrical output terminal of the photodetector is connected to an input terminal of the first amplifying filter and an input terminal of the second amplifying filter respectively, an output terminal of the first amplifying filter and an output terminal of the second amplifying filter are connected to an input terminal of the first analog-to-digital converter and an input terminal of the second analog-to-digital converter respectively, an output terminal of the first analog-to-digital converter and an output terminal of the second analog-to-digital converter are both connected to the FPGA bias control module, the FPGA bias control module is connected to a bias control terminal of the Mach-Zehnder modulator through the digital-to-analog converter and the bias amplifier in sequence, and the electrical pulse generator is connected to an RF radio frequency input terminal of the Mach-Zehnder modulator.

2. The bias control device based on pulse phase stabilization for the Mach-Zehnder modulator according to claim 1, wherein the first amplifying filter is a low-pass filter, and the second amplifying filter is a band-pass filter.

3. The bias control device based on pulse phase stabilization for the Mach-Zehnder modulator according to claim 1, wherein the FPGA bias control module comprises a first phase-locked amplifier, a second phase-locked amplifier, and a bias generator, input terminals of the first phase-locked amplifier and the second phase-locked amplifier are connected to the output terminal of the first analog-to-digital converter and the output terminal of the second analog-to-digital converter, respectively, an output terminal of the first phase-locked amplifier and an output terminal of the second phase-locked amplifier are both connected to an input terminal of the bias generator, an output terminal of the bias generator is connected to an input terminal of the digital-to-analog converter.

4. The bias control device based on pulse phase stabilization for the Mach-Zehnder modulator according to claim 1, wherein,
an output terminal and the another output terminal of the optical fiber coupler conduct light splitting processing, separating a small portion of light to the photodetector for further bias control.

5. A bias control method for the bias control device for the Mach-Zehnder modulator according to claim 1, wherein the bias control method is implemented with an optical pulse with a wavelength λ and a repetition frequency fᵣₑₚ output from the mode-locked femtosecond laser being coupled into the Mach-Zehnder modulator, the electrical pulse generator outputs an electrical pulse signal with a frequency f_{pick} to the RF radio frequency input terminal of the Mach-Zehnder modulator for pulse modulation, wherein the Mach-Zehnder modulator outputs an optical pulse signal to the optical fiber coupler, through the optical fiber coupler, a portion of the light is separated and detected by the photodetector, the optical pulse signal is converted into an electrical signal by the photodetector and divided into two paths, along one of the paths, the light passes through the first amplifying filter and the first analog-to-digital converter to obtain a low-frequency digital signal S₁(t) with a same frequency f_{pick} as the electrical pulse signal, along the other path of the paths, the light passes through the second amplifying filter and the second analog-to-digital converter to obtain a high-frequency digital signal S₂(t) with a same frequency fᵣₑₚ as an output of the mode-locked femtosecond laser, finally, the low-frequency digital signal S₁(t) and the high-frequency digital signal S₂(t) are sent to the FPGA bias control module for data processing, the FPGA bias control module processes signals and outputs a bias control signal V_{b} through a digital-to-analog converter, the bias control signal V_{b} is amplified by the bias amplifier and then configured to control a bias of the Mach-Zehnder modulator.

6. The bias control method for the bias control device for the Mach-Zehnder modulator according to claim 5, wherein,
in an initial situation, the bias generator of the FPGA bias control module scans a cycle of triangular wave voltage for the bias control signal, and sets the electrical pulse signal output by the electrical pulse generator as zero, then, the second phase-locked amplifier demodulates an amplitude of the high-frequency digital signal in real time, and obtains the bias control signal corresponding to the minimum amplitude through scanning as an initial bias to be input into the Mach-Zehnder modulator.
